(19) United States
(12) Patent Application Publication
(10) Pub. No.: US 2001/0047967 A1
(43) Pub. Date: Dec. 6, 2001

(54) METHOD AND APPARATUS FOR SEPARATING AN IMMISCIBLE LIQUID/LIQUID MIXTURE CONTAINING SOLID MATTER

(76) Inventors: KENNETH M WILLIAMSON, JAMESVILLE, NY (US); SCOTT A. WHITNEY, MARATHON, NY (US); RICHARD C. STOYELL, JR., MORAVIA, NY (US)

Correspondence Address: LEYDIG VOIT & MAYER, SUITE 300, 700 THIRTEENTH STREET NW, WASHINGTON, DC, 20005

(21) Appl. No.: 08/983,066

(22) PCT Filed: Jan. 31, 1996
(86) PCT No.: PCT/US96/01630

§ 371 Date: None

(51) Int. Cl. B01D 17/04

(52) U.S. Cl. 210/799; 210/315

(57) ABSTRACT

A purification system for separating phases of a solid/liquid/liquid mixture includes at least one cylindrical filter element including a filter medium for removing solid particulate matter, the filter medium having a bubble point of at least about 200 inches of water, and at least one coalescing element in spaced relationship to the filter medium for coalescing into droplets a first liquid of a solid/liquid/liquid mixture, which first liquid is wholly or partly immiscible in and forms a discontinuous phase with a second continuous phase-forming liquid of the solid/liquid/liquid mixture. The filter element may be detachably mounted adjacent to the coalescer element. A method for separating a solid/liquid/liquid mixture into individual phases includes passing the mixture through at least one filter element including a filter medium having a bubble point of at least about 200 inches of water to remove solid particulate matter and thereafter passing the resultant liquid mixture from which solid particulate matter has been removed and in which a first liquid is wholly or partially immiscible in and forms a discontinuous phase with a second continuous phase-forming liquid to coalesce the first liquid into droplets.

The present invention is directed to a method for separating individual phases of a solid/liquid mixture, which mixture includes first and second immiscible liquids and solid matter dispersed in at least one of the liquids. More particularly, the invention is directed to a method of separating and removing solids having a particle size of as small as 0.5 micron (μm), as well as small amounts of an immiscible liquid phase, from a continuous liquid phase and to a filtering/coalescing/separating system used therefor.

Many industrial processes and apparatus, as well as household devices, relate to the separation of a liquid phase from another phase. In some instances, particularly when water is the phase present in minor amounts, chemical means may be used to remove the water from the other components. Such means for removing moisture, however, require the replacement and/or regeneration of the reagents used in the process. The reagents employed and the products formed frequently introduce complications relating to handling and disposal. Because of the concomitant cost and, in some instances, inconvenience associated with such processes, physical methods and apparatus have been preferred to chemical means for removal of small amounts of a liquid phase from other phases.

A method of coalescing an immiscible liquid suspended in another phase and a coalescing device, frequently termed a “coalescer”, have found widespread use in removing liquid from both a gaseous phase, such as in aerosols, and from suspensions of one liquid in another liquid. Such devices are particularly effective where the volume of liquid removed is small in comparison to the volume of the phase from which it is removed. Typically, the equipment necessary to remove a liquid aerosol from a gas tends to be less complicated than that used to separate two liquid phases in which a first liquid phase is immiscible and suspended in a second liquid phase. This is generally true because in air/liquid suspensions, gravitational effects tend to be more significant while surface energy, surface tension or interfacial tension effects tend to be less significant than with liquid/liquid suspensions.

The spectrum of applications where coalescers have been used to remove minor amounts of a first liquid phase, known as a “discontinuous phase” or “suspended phase”, from a second liquid phase in which it is suspended, known as the “continuous phase” or “suspending phase”, covers a considerable range of situations. For example, coalescers have been used most often to remove or separate small amounts of moisture from petroleum-based fuels, including gasoline, diesel and aviation fuels, such as kerosene; remove moisture from cleaning fluids; separate oil from coolants and parts cleaners; remove oil contamination found in natural bodies of water; separate immiscible solvent systems used in extraction processes, etc.

In addition to the need for separating liquid phases, many applications also require the separation of solid phase matter, i.e., solids, such as particulate matter and colloidal matter, from an immiscible mixture of liquids. A common example is in the purification of the above mentioned petroleum-based fuels. These fuels are stored in outdoor storage tanks which are subject to corrosion and leakage as well as to periodic cleaning. Water can accumulate in the tanks due both to leakage from the outside and from residual aqueous fluids used in cleaning the tanks. Likewise, the fuel as delivered to the storage tanks may itself contain moisture.

The presence of moisture in the storage tanks further promotes corrosion. This corrosive effect results in liberation of small particles of metal oxides, primarily iron oxides, from the tank walls, which then become suspended in the continuous fuel phase and/or in the discontinuous water phase. Other solids may also be present, for example, paint chips or dirt particles, some of which may also be suspended in either or both of the fuel and water phases.

If the fuel is to be used in a combustion engine such as a gasoline, diesel or jet engine, the solids can damage various metal parts which are machined to high tolerances. Solids as small as 0.5 μm has been known to cause damage to engine parts. A highly efficient removal of the solids is hence imperative for these applications.

Generally, it has been the practice in the art to remove particulate matter, either prior to or after coalescing and separating the immiscible mixture, by filtration with a suitable filter medium.

Filter media previously used for this purpose have had a bubble point of about 60 inches of water. The Bubble Point test is a measure of porosity whereby the filter medium is suspended in a liquid bath (usually denatured ethyl alcohol) and air is applied to one side of the medium at increasing pressure. The pressure at which the first bubble appears on the other side of the medium is termed the bubble point and is measured in inches of water. In the past, for many petroleum-based fuels, such filter media were satisfactory for removing particulate matter having a particle size of 0.5 μm or less.

In many current applications, however, such filter media are incapable of adequately removing solids. In particular, certain recently developed petroleum-based fuels simply cannot be filtered adequately when water is present. Attempts to filter such fuels with previously used filter media result in only partial removal of particles having a particle size down to 0.5 μm. This, despite the fact that the same filter media were previously successful in removing the same size particles from other apparently similar fuels.

The prior art provides no explanation for this phenomenon. Certain fuel additives are known to have a surface active or surfactant effect but no connection has heretofore been made between a surfactant effect and inadequate filtration of very small particulate matter. Surfactants have been known, for example, to reduce agglomeration of particulate matter, usually in an aqueous phase.

This phenomenon would seem irrelevant, however, in situations where no significant agglomeration is believed to occur even in the absence of a surfactant. This is the case in many petroleum-based fuel applications. Inspection of unfiltered fuel usually reveals many indivisible particles down to 0.5 μm, even for those fuels which are adequately filtered by a medium having a bubble point of 60 inches of water. Turbulence and shear forces encountered in pumping the unfiltered fuel to and from the storage tanks and to the filter may be partly responsible for breaking up any agglomeration that may have occurred.

In any event, the prior art provides neither a solution nor satisfactory explanation as to why identical filter media will filter some fuels and not others, given that all tested fuel types have similar size particulate matter. Hence, there is a need in the art for a purification system which is capable of filtering particulate matter down to about 0.5 μm as well as coalescing and separating an immiscible liquid from a fuel regardless of the fuel composition.

The present invention provides purification assembly for separating phases of a solid/liquid/liquid mixture comprising at least one cylindrical filter element including a filter medium for removing solid matter from said solid/liquid/liquid mixture, said filter medium having a bubble point of at least about 200 inches of water, and at least one coalescing element located downstream of said filter element for coalescing into droplets a first liquid of the solid/liquid/liquid mixture, which first liquid is wholly or partly immiscible in and forms a discontinuous phase with a second continuous phase-forming liquid of said solid/liquid/liquid mixture.

The present invention also provides a purification system capable of separating into individual phases a solid/liquid/liquid mixture comprising a first liquid, a second liquid, and solid matter dispersed in at least one of said first and second liquids, said first liquid being wholly or partly immiscible in and forming a discontinuous phase with said second, continuous phase-forming liquid, the system comprising a housing, a liquid inlet in said housing, a first liquid outlet in said housing, a second liquid outlet in said housing, at least one coalescing element in said housing for coalescing said first liquid into droplets, and at least one filter element in said housing for removing solids from said first and second liquids, said filter element including a filter medium and said filter medium having a bubble point of at least about 200 inches of water, wherein the filter element is positioned in a flow path upstream of the coalescer element.

The present invention further provides a method for separating a solid/liquid/liquid mixture into individual phases comprising passing the mixture through at least one filter element including a filter medium having a bubble point of at least about 200 inches of water to remove solid matter from said solid/liquid/liquid mixture and thereafter passing the resultant liquid mixture from which said solid matter has been removed and in which a first liquid is wholly or partially immiscible in and forms a discontinuous phase with a second continuous phase-forming liquid to a coalescer element to coalesce said first liquid into droplets.

The present invention additionally provides a method for separating a solid/liquid/liquid mixture into individual phases, said solid/liquid/liquid mixture comprising water, a petroleum-based liquid, an additive, and solid matter dispersed in at least one of said water and said petroleum-based liquid, said water being wholly or partly immiscible in and forming a discontinuous phase with said petroleum-based, continuous phase-forming liquid, comprising the steps of passing the mixture through a filter element including a filter medium having a bubble point of at least about 200 inches of water, passing the filtered mixture into a coalescer element for coalescing said water into droplets, and passing the mixture of coalesced water and the petroleum-based liquid to a separator element for separating the coalesced water from the petroleum-based liquid.

Assemblies, systems, and methods embodying these aspects of the invention overcome many of the problems of separating solids in certain applications, particularly in selected petroleum-based or hydrocarbon-based fuel applications. The invention derives in part from the unexpected discovery that a filter medium having a very high bubble point, on the order of at least about 200 inches of water, preferably at least about 250 inches and more preferably at least about 300 inches and even more preferably at least about 400 inches of water will filter out small solids, down to about 0.5 μm particle size or even smaller, in applications which heretofore have resisted filtration with lower bubble point filter media. This discovery was unexpected because the previously-used lower bubble point filter media, for example, media having a bubble point of about 60 inches of water, were formerly believed to have a pore size small enough to trap particulate matter down to about 0.5 μm particle size. Indeed, in most applications, a bubble point of 60 inches is more than adequate to trap 0.5 μm particles. The failure of the previously used media in certain applications was hence not attributed to inadequately small pore size.

While the invention is not to be bound by a particular theory, it is speculated that in a solid/liquid system which includes two or more wholly or partially immiscible phases together with dispersed solids, a certain amount of particle agglomeration does normally take place. This agglomeration, while usually not observable or present upon analytical sampling of the solid/liquid mixture immediately prior to filtration, is believed to occur during the filtration process itself. As the unagglomerated particles pass into the filter medium, they are placed in closer and closer proximity to each other and eventually form agglomerates while, at the same time, the turbulence and shear forces present in the fluid flow upstream of the filter are greatly reduced. The result is agglomeration within the filter medium itself. Hence, in the past, petroleum-based fuels containing particles having a nominal size as small as 0.5 μm could be filtered using a 60 inch bubble point medium since the medium “sees” a larger agglomerated particle which is filtered by direct interception.

Another phenomenon believed to be involved in filtering very small particles is inertial impaction. As the solid/liquid mixture flows around individual fibers or through the pores of a filter medium, particles of a certain size or density range will deviate from the tortuous flow path and impact upon the fibers or internal walls which define the pores. The impacted particles adhere to the fibers or walls by forces such as Van der Waals' forces while still being acted upon by forces from the fluid flow. Larger particles have a higher probability of impaction but are also subject to larger hydrodynamic forces which may overcome the adhesive forces and pull them away from the fibers or pore walls. Solids are also believed to be retained in the fibers or pore walls due to boundary layer effects, such as eddy currents, which allow the particles to avoid being swept away by the main fluid flow through the medium.

In the solid/liquid systems under consideration, solids of from about 0.5 μm to about 2 μm can normally be removed by inertial impaction. Because this phenomenon does not rely directly upon pore size for particle entrapment, as in direct interception, the actual pore size of the filter medium may be larger than the size of particles removed.

These two mechanisms, agglomeration and inertial impaction, are together believed to account for the ability of filter media with relatively large pore sizes, for example, 60 inch bubble point, to filter particles down to about 0.5 μm in particle size, at least in many solid/liquid systems.

When one or both of these mechanisms is rendered inoperative, however, filtration of very small particles is prevented. This is believed to occur in the filtration of petroleum-based fuels having certain additives which, although included perhaps for a different purpose, have a surfactant effect on the particulate matter, particularly when water is present with the fuel. Additives are used to enhance the performance of the fuel in a number of ways. In a specific example, thermal stability additives can decrease carbon build up when the fuel is preheated by engine exhaust and/or used to cool the combustion chamber.

The surfactant effect of additives can inhibit the agglomeration of particulate matter by interfering with the ability of the particles to agglomerate as they enter the filter medium. Likewise, the surfactant effect is believed to interfere with inertial impaction by decreasing Van der Waals' forces acting on the particles and/or by decreasing the boundary layer effects in the fluid flow around the fibers or membrane walls. Thus, the particles are not retained on the fibers or walls as previously described.

Many embodiments of the present invention provide a solution to this problem by decreasing the pore size of the filter medium to a level which allows significant filtration via direct interception of unagglomerated particles having a particle size of about 0.5 μm or smaller. Thus, these embodiments of the present invention include a filter element provided with a filter medium having a bubble point of at least about 200 inches of water, preferably at least about 250 inches of water, more preferably at least about 300 inches of water and in some situations, such as when the pressure across the filter surges, even more preferably at least about 400 inches of water. This bubble point is significantly higher than that heretofore used to separate particulate matter from a mixture of immiscible liquids of the type described above. The success of these embodiments in using a high bubble point medium was unexpected since, as discussed above, the prior art did not consider low porosity to be a factor in the failure of prior art filter media.

The present invention also provides a purification assembly for separating phases of a solid/liquid/liquid mixture including solids and first and second liquids in which the first liquid is wholly or partially immiscible in and forms a discontinuous phase with the second, continuous phase-forming liquid, the purification assembly comprising a cylindrical filter element including a filter medium for removing solids from said solid/liquid/liquid mixture and a cylindrical coalescer element for coalescing into droplets said first liquid, wherein said cylindrical filter element is detachably mounted coaxially with said cylindrical coalescer to facilitate replacement of the filter element.

The present invention further provides a method for purifying a solid/liquid/liquid mixture including solids and first and second liquids, the first liquid being wholly or partly immiscible in and forming a discontinuous phase with said second, continuous phase-forming liquid, the method comprising directing a flow of the mixture through a first filter element to filter the solids from the mixture and then through a first coalescer element to coalesce the first liquid into droplets, interrupting the flow through the first filter element and the first coalescer element, removing the first filter element from a position adjacent to the first coalescer element, detachably mounting a second filter element adjacent to the first coalescer element, and directing a flow of the mixture through the second filter element and then through the first coalescer element.

Assemblies and methods involving these aspects of the invention are highly efficient and economical. Filter elements, especially filter elements having a bubble paint greater than 200 inches of water, frequently foul much faster than a coalescer element. By providing a filter element which can be changed out and replaced with a new or clean filter element, the efficiency and effectiveness of these purification assemblies and methods can be maintained at a high level while waste is minimized.

For a full understanding of the invention, the following detailed description should be read in conjunction with the drawings, wherein:

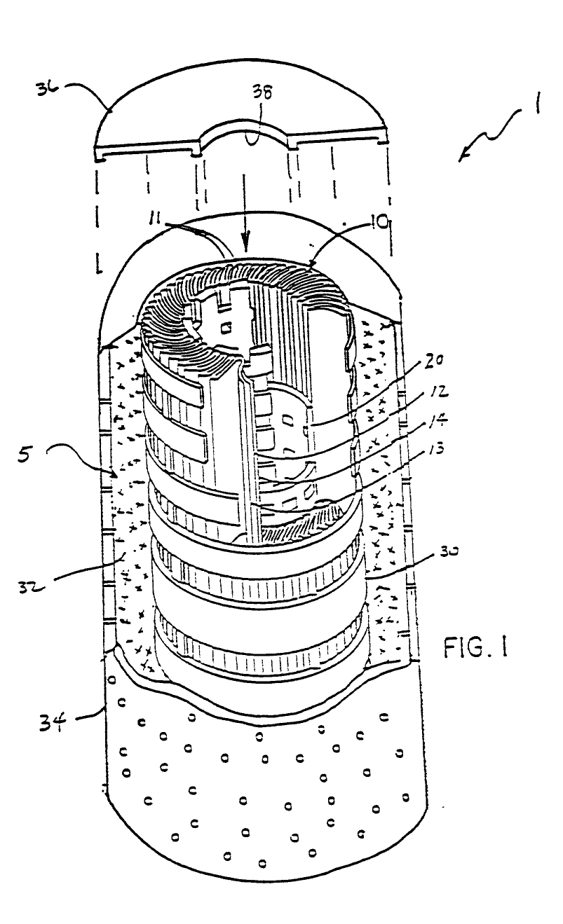

FIG. 1 is a cut-away perspective and partially exploded view of a filter/coalescer assembly wherein a filter element is coaxially arranged within a coalescing element;

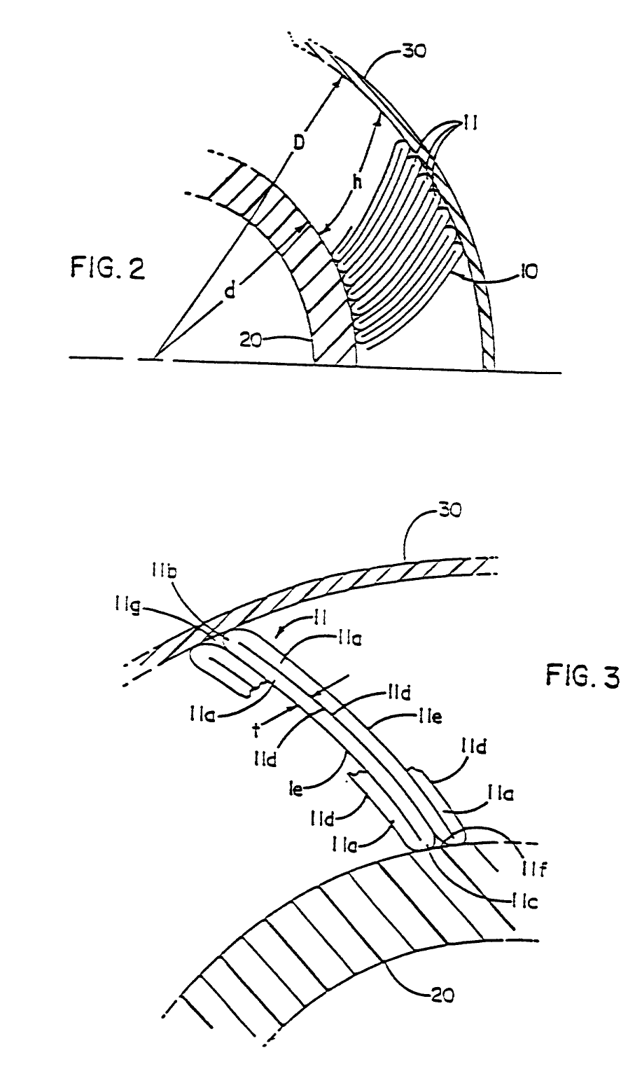

FIG. 2 is a transverse cross-sectional view of a portion of the filter element of FIG. 1;

FIG. 3 is an enlarged cross-sectional view of one of the pleats of FIG. 2;

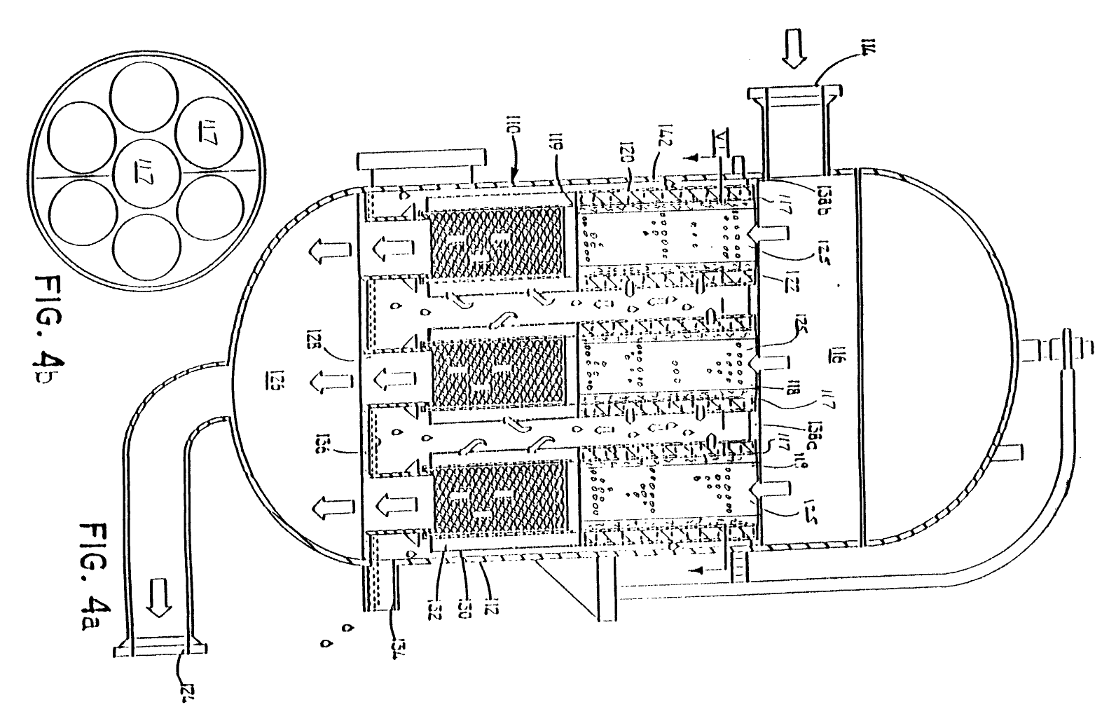

FIG. 4a illustrates a plurality of filtering elements arranged within coalescing elements and superposed above separating elements; and

FIG. 4b is a sectional view of the embodiment of FIG. 4a taken along line IV-IV.

As indicated above, embodiments of the present invention are directed to the filtering, coalescing, and separating of solid/liquid mixtures which include a first liquid, a second liquid, and solid particulate matter dispersed in at least one of the liquids and in which the first liquid is wholly or partly immiscible in and forms a discontinuous phase with the second continuous phase-forming liquid (alternatively termed “solid/liquid/liquid mixtures”).

In describing the present invention, terms such as “coalescer”, “coalescing element”, “coalescing unit” and like terms, in both singular and plural, have been used to describe the device or article which coalesces the discontinuous or polydivided phase of a mixture of immiscible liquids to form droplets. Regardless of the term used, the coalescing step employing such device occurs in the same manner. While the term “coalescer” generically describes such a device and the term “coalescing element” describes one component unit or cartridge of a system which may contain multiple coalescing and separating units, the present invention may be construed as containing as few as one coalescer unit in a coalescer-separator system or a plurality of such units. In addition, such coalescing units may be fixed and not removable (without doing significant damage to the system), or preferably, contain easily removable and replaceable elements. In a similar manner, terms such as “separator”, “separating element”, “separator units”, and like terms have meanings similar to each other as do those relating to coalescers, discussed above.

The terms “filter”, “filter element”, and “filter assembly” are used to describe the device or article or a component thereof which filters particulate matter from a liquid.

With reference to the drawings, and particularly to FIG. 1, the embodiment of this figure employs a filter element having a configuration with laid-over pleats, the advantages of which are set forth in International Publication No. WO94/11092, which is hereby incorporated by reference in its entirety.

As shown in FIG. 1, one embodiment of a filter/coalescer assembly is generally indicated by the number 1. The assembly 1 is generally cylindrical in form and includes a coalescer element 5 and a pleated filter element 10 having a filter medium formed into a plurality of longitudinal pleats 11. The filter medium preferably has a bubble point of at least about 200 inches of water and in some situations, such as when the pressure across the filter surges, at least about 400 inches of water. The filter medium also preferably has a removal rating of at most about 0.8 microns, more preferably at most about 0.68 microns, more preferably at most about 0.45 microns, and when the pressure across the medium varies considerably, such as by surging or pulsing, even more preferably at most about 0.2 microns. In addition, the filter medium, like the other materials used in embodiments of the invention, should not interact chemically or physically (e.g., dissolving or significantly swelling) with any of the materials being filtered.

The filter medium can be selected in accordance with the fluid which is to be filtered and the desired filtering characteristics. The filter medium may comprise a porous film, such as a membrane, or a fibrous sheet or mass such as a woven and nonwoven webs, in which the fibers may be bonded or non-bonded; it may have a uniform or graded pore structure; it may be formed from any suitable material, such as a natural or synthetic polymer. For example, the filter medium can be an aromatic polyamide, a linear polyamide, a polycarbonate, a polysulfone, a polyester such as polyethylene terephthalate (PET) or polybutylene terephthalate (PBT) or polytetrafluoroethylene (PTFE). Highly preferred are aramid fibers as described in the United Kingdom specification published under Publication No. 2288825 on Nov. 1, 1995, which is hereby incorporated by reference in its entirety.

A cylindrical core 20 may be coaxially disposed along the inner periphery of the filter element 10, and a cylindrical cage or wrap 30 may be disposed along the outer periphery of the filter element 10. Preferably, and as shown in FIG. 1, the cage 30 of the filter element 10 defines the core of the coalescer 5. Surrounding the cylindrical cage 30 is coalescer packing 32 which is supported by a perforated cage 34. Packing 32 can be constructed of any one of many well known materials. Preferred as the packing material are polyesters such as polybutylene terephthalate or polyethylene terephthalate. Other materials include those set forth in U.S. Pat. No. 5,443,724, which is hereby incorporated by reference in its entirety. End cap 36 having an inlet 38 fits over one end of the assembly 1. The filter element 10 and the coalescer element 5 either share a common blind end cap (not shown) at the end opposite the inlet 38 or each element has a separate blind end cap.

As shown in a preferred embodiment in FIGS. 2 and 3, each pleat 11 of the filter element 10 has two legs 11a which are joined to one another at the crown 11b of the outer periphery of the filter element 10 and which are joined to a leg 11a of an adjacent pleat 11 at the root 11c of the inner periphery of the filter element 10. Each leg 11a has an internal surface 11d which opposes the internal surface 11d of the other leg 11a in the same pleat 11, and an external surface 11e which opposes the external surface 11e of a leg 11a of an adjacent pleat 11.

Liquid flows radially outwardly from the cylindrical core 20, through the pleats 11, and into the coalescer 5. The liquid then flows out through the perforated cage 34, and if necessary, to a separator assembly (not shown). It is also possible, but less preferred, to have the fluid flow radially inwardly with the filter defining the outer periphery of the assembly and the coalescer contained within the core of the filter. In this case, fluid flows out through the coalescer core.

When the filter element 10 is being used such that fluid flows radially inwardly through the element and then into the coalescer, the internal surfaces 11d of the legs 11a form the downstream surface of the filter element 10, while the external surfaces lie form the upstream surface of the filter element 10. Alternatively, and as shown in FIG. 1, when the filter element 10 is being used such that fluid flows radially outwardly through the element, the internal surfaces 11d and the external surfaces 11e respectively form the upstream and downstream surfaces of the filter element 10.

The opposing inner surfaces lid of the legs 11a of each pleat 11 are in intimate contact with one another over substantially the entire height h of the legs 11a and of the pleat 11 and over a continuous region extending for a significant portion of the axial length of the filter element 10. In addition, the opposing external surfaces 11e of the legs 11a of adjacent pleats 11 are in intimate contact over substantially the entire height h of the adjacent pleats 11 and legs 11a and over a continuous region extending for a significant portion of the axial length of the filter element. Here, the height h (shown in FIG. 2) of the pleats 11 and the legs 11a is measured in a direction along the surfaces of the legs 11a and extends from the inner periphery to the outer periphery of the filter element 10. The condition illustrated in FIGS. 2 and 3 in which the surfaces of the legs 11a of the pleats 11 are in intimate contact and in which the height h of each pleat 11 is greater than the distance between the inner and outer peripheries of the filter element 10 (i.e., [D−d]/2 in FIG. 2) is referred to as a laid-over state. In the laid-over state, pleats may extend, for example, in an arcuate or angled fashion or in a straight, non-radial direction, there may be substantially no empty space between adjacent pleats, and virtually all of the volume between the inner and outer peripheries of the filter element 10 may be occupied by the filter element 10 and can be effectively used for filtration.

Because the filter element 10 is formed from a material having a finite thickness t, at the radially inner and outer ends of the pleats 11 where the filter element 10 is folded back upon itself to form the pleats 11, the pleats 11 will be somewhat rounded. As a result, at the radially inner ends of the pleats 11, small triangular gaps 11f are formed between the opposing internal surfaces 11d of adjoining legs 11a, and at the radially outer ends of the pleats 11, small triangular gaps 11g are formed between the opposing external surfaces 11e of adjoining legs 11a. However, preferably, the height of these gaps 11f and 11g as measured along the height of the pleats is preferably extremely small. The height of the gaps 11f adjoining the inner diameter of the filter element 10 is no more than approximately t and more preferably no more than approximately ½ t, wherein t is the thickness of the material forming the filter element 10, as shown in FIG. 3. The height of the gaps 11g adjoining the outer diameter of the filter element 10 is preferably no more than approximately 4 t and more preferably no more than approximately 2 t. The sharper the pleats 11, i.e., the less rounded are their radially inner and outer ends, the smaller can be the heights of the gaps 11f and 11g and the greater can be the percent of the volume between the inner and outer peripheries of the filter element 10 which is available for filtration.

The opposing surfaces of adjoining legs 11a of the pleats need not be in intimate contact over the entire axial length of the filter element 10, but the greater is the length in the axial direction of the region of intimate contact, the more effectively used is the space between the inner and outer periphery of the filter element 10. Therefore, adjoining legs 11a are in intimate contact over a continuous region which preferably extends for at least approximately 50%, more preferably at least approximately 75%, and most preferably approximately 95-100% of the axial length of the filter element 10.

The filter element 10 includes a filter medium and drainage means disposed on at least one side, preferably the upstream side, and more preferably on both the upstream and downstream sides of the filter medium. The drainage means prevents opposing surfaces of the filter medium from coming into contact with one another and enables fluid to evenly flow to or from substantially all portions of the surface of the filter medium when the pleats are in the laid-over state. Thus, virtually the entire surface area of the filter medium may be effectively used for filtration.

In the embodiment of FIG. 1, the filter element 10 comprises a three-layer composite of a filter medium 12, upstream drainage means in the form of an upstream drainage layer 14 disposed on the upstream surface of the filter medium 12, and downstream drainage means in the form of a downstream drainage layer 13 disposed on the downstream surface of the filter medium 12. Here, upstream and downstream surfaces may refer to the exterior and interior surfaces when the filter is being subjected to radially inward fluid flow or to interior and exterior surfaces when the filter is being subjected to radially outward fluid flow. As mentioned above, the latter arrangement is preferred in an embodiment of the invention which combines a filter element and a coalescer element in a single unit.

The filter medium 12 may comprise a single layer, or a plurality of layers of the same medium may be disposed atop one another to a desired thickness. Furthermore, it is possible for the filter medium to include two or more layers having different filtering characteristics, e.g., with one layer acting as a prefilter for the second layer.

The upstream and/or downstream drainage layers of the filter medium may be regions of a single, unitary porous sheet having a finely-pored center region, which serves as a filter medium, and coarsely-pored upstream and/or downstream regions which serve as the drainage layers. However, the drainage layers are preferably distinct layers separate from the filter medium.

The upstream and downstream drainage layers 14 and 13 can be made of any materials having suitable edgewise flow characteristics, i.e., suitable resistance to fluid flow through the layer in a direction parallel to its surface. The edgewise flow resistance of the drainage layer is preferably low enough that the pressure drop in the drainage layer is less than the pressure drop across the filter medium, thereby providing an even distribution of fluid along the surface of the filter medium. The drainage layers can be in the form of a mesh or screen or a porous woven or non-woven sheet.

Meshes and screens (also called netting) come in various forms. For high temperature applications, a metallic mesh or screen may be employed, while for lower temperature applications, a polymeric mesh may be particularly suitable. Polymeric meshes come in the form of woven meshes and extruded meshes. Either type may be employed, but extruded meshes are generally preferable because they are smoother and therefore produce less abrasion of adjoining layers of the filter composite. An extruded mesh may have a first set of parallel strands lying in a first plane and a second set of parallel strands lying in a second plane and intersecting the first set of strands at an angle between 0° and 90°. Extruded meshes may be classified as either symmetrical or non-symmetrical. In a symmetrical mesh, neither of the first or second sets of strands extends in the so-called “machine direction” of the mesh, which is the direction in which the mesh emerges from a mesh manufacturing machine. In a non-symmetrical mesh, one of the sets of strands extends parallel to the machine direction. In the present invention, it is possible to use either symmetrical or non-symmetrical meshes. Nonsymmetrical meshes have a somewhat lower resistance to edgewise flow per thickness than do symmetrical meshes. Therefore, for a given edgewise flow resistance, a nonsymmetrical mesh can be thinner than a symmetrical mesh, so the number of pleats in a filter element 10 using a non-symmetrical mesh can be larger than for a filter element of the same size using a symmetrical mesh. On the other hand, symmetrical meshes have the advantage that they are easier to work with when manufacturing a pleated filter element 10.

Meshes may be characterized by their thickness and by the number of strands per inch. These dimensions are not limited to any particular values and can be chosen in accordance with the desired edgewise flow characteristics of the mesh and the desired strength. Typically, the mesh will have a mesh count of at least 10 strands per inch.

The filter composite forming the filter element 10 may include other layers in addition to the filter medium 12 and the drainage layers 13 and 14. For example, in order to prevent abrasion of the filter medium due to rubbing contact with the drainage layers when the pleats expand and contract during pressure fluctuations of the fluid system in which the filter is installed, a cushioning layer can be disposed between the filter medium and one or both of the drainage layers. The cushioning layer is preferably made of a material smoother than the drainage layers and having a higher resistance to abrasion than the filter medium 12. For example, when the drainage layers are made of an extruded nylon mesh, an example of a suitable cushioning layer is a polyester non-woven fabric such as that sold under the trade designation Reemay 2250 by Reemay Corporation.

The layers forming the filter element 10 can be formed into a composite by conventional filter manufacturing techniques, either prior to or simultaneous with corrugation.

While the above description relates to a specific preferred embodiment for the filter construction, it will be appreciated that other filter designs are equally suitable. For example, although less preferred, the filter medium need not be in a laid-over configuration. Rather, it can be arranged in the more conventional fan or radial configuration in which the pleats extend radially outward from the core. In another embodiment of the present invention the filtration element may be placed in a separate housing located upstream of the coalescing element. The filter medium used preferably has a bubble point of at least about 200 inches of water, preferably at least about 250 inches of water, most preferably at least about 300 inches of water, and in many instances, particularly when the pressure across the filter medium is uneven, such as when pressure pulses or surges occur, at least about 400 inches of water. It will further be appreciated that bubble points higher than 400 inches of water can be used provided that the flow rate and pressure drop across the filter medium is acceptable in a particular application.

In another embodiment of the present invention, the filter may be formed as an element, unit or cartridge which is separately removable and replaceable with respect to the coalescer element, unit or cartridge. A filter, especially a filter having a bubble point greater than 200, 300, or 400 inches of water, may foul more quickly and require replacement more often than the coalescer. Consequently, the filter of the filter/coalescer assembly is preferably detachably mounted with respect to the coalescer. For example, the filter/coalescer assembly 1 shown in FIG. 1 may be modified to provide separate end caps of the coalescer element 5 and the filter element 10 which would allow the filter element 10 to be axially moved with respect to the coalescer element 5. A fouled filter element may then be axially removed from a position adjacent to the interior (or exterior) of the coalescer element 5 and a new or cleaned filter element may be axially replaced in the interior (or exterior) of the coalescer element 5. Concomitantly, the housing containing the filtration and coalescing elements may be provided with a means for removing and replacing the filtration element 10, such as a removable end cap or portion thereof. Thus, the cap may be attached to the outer cylindrical wall or cage of the housing using commensurately configured threading, bayonet fitting or pressed fitting and appropriate O-ring or other seal.

FIG. 4a shows a plurality of filter/coalescer/separator assemblies. It will be appreciated, however, that a single such assembly can be employed and that a filter and coalescer assembly may be employed without integral separator elements. Further, in some applications, particularly those in which the specific gravities of the liquids to be separated are sufficiently different, there is no need for a separator at all.

In the embodiment of FIG. 4a, a filtering/coalescing/separating assembly 110 includes a housing 142. A plurality of filtering/coalescing assemblies 117 are individually superposed above a plurality of separating elements 130. Within each coalescing element 120 of each filtering/coalescing assembly 117 is positioned a filter element 125 which is preferably removably mounted adjacent to the interior of the coalescing element 120. Each filtering element 125 may have the laid-over pleat configuration shown in FIG. 1. Other designs may alternatively be used. The filtering elements 125, coalescing elements 120, and separating elements 130 are located within housing 112. A liquid inlet is provided in a wall of the housing for introducing liquid, in this embodiment, above the filter elements. Liquid inlets 118 are provided in the upper end of each cylindrical filtering element 125 for introduction of contaminated liquid thereto. Each coalescing element has a packing which defines the cylindrical wall 122 of the coalescing element.

In operation, a mixture of solids and immiscible liquids including continuous and discontinuous phases is introduced to the housing 112 through the immiscible liquid inlet 114. For example, the mixture may comprise a petroleum-based liquid, such as a jet fuel, as the continuous phase; water as the discontinuous phase; solids, such as iron oxide; and an additive which may act as a surfactant. After entering the housing, the mixture flows in the direction of the arrows shown in FIG. 4a. Namely, liquid enters each filtering element 125 through the inlet portion 118 in one of the end caps 119 and, since the other end cap seals the unit completely, liquid flows through the filter medium where the solids are removed and into the porous packing which defines the wall 122 of each coalescing element where the discontinuous phase is formed into droplets. In a highly preferred embodiment, the packing contains a material which has a critical wetting surface energy intermediate the surface tensions of the liquids forming the continuous and discontinuous phases.

Each filter/coalescing element is held in fixed position with respect to another juxtaposed filter/coalescing element and/or to the housing wall. This may be achieved by specific locating and/or fixing means (not shown) or, alternatively, at least in part, by using liquid barriers 138a, located between elements, or by liquid barriers 138b, located between elements and the interior wall. These barriers may be formed in separate sections or as a single unit. These liquid barriers primarily act as liquid sealing elements and assure that the liquid flowing into the housing under the force of gravity or an additional pressure can only flow to the bottom of the housing by first entering the inlet portion 118 of each of the filtering elements flowing through the walls thereof and into the coalescing elements 130 and finally through the walls of the coalescing elements.

After passing through the wall of the coalescing elements 120 in an inside-out direction, the continuous phase liquid flows into each separating elements 130 through a wall portion 132 in an outside-in direction. Due to the composition from which the external wall of the separating element is formed or on which a coating is placed, only the continuous phase enters the separating element, leaving many of the droplets of the discontinuous phase liquid formed by the coalescing elements to fall to the partition or bottom 136 located between and below the separating elements. This liquid is then removed from the housing through the discontinuous phase outlet or drain 134. The continuous phase liquid passes out of each separating element through outlet 128 into the outlet chamber 126 where it passes from the housing through continuous phase outlet 124.

Once the filter elements 125 become fouled, flow of the mixture through the housing 112 may be interrupted and the cover of the housing 112 may be removed. The fouled filter element 125 may then be replaced by new or clean filter elements 125. For example, each fouled filter element 125 may be removed axially from the interior of the corresponding coalescer element 120. Alternatively, the filter elements 125 may be replaced for other reasons. For example, a filter element 125 which includes a filter medium having a bubble point of about 200 inches of water may be replaced with a filter element which has a filter medium having a larger (or smaller) bubble point, e.g., a bubble point of about 300 inches or 400 inches of water or more. In any event, after all of the old filter elements 125 have been replaced, the cover may be locked onto position and a flow of the mixture may be reestablished through the housing 112, where the mixture is directed through the filter elements 125, the coalescer elements 120, and the separator elements 130.

Each separating element 130 includes a perforated wall 132 which is formed from, or has an outer surface coating of, a material which repels (or is not wetted by) a liquid of the discontinuous phase, which may be termed the “discontinuous phase barrier material”. Such a material should not react with any liquid or other substance present in the mixture of immiscible liquids. When used as a coating on the wall of the separator, such material should remain substantially immobilized thereon. Typically, the critical wetting surface energy of this material is selected to permit passage of the liquid forming the continuous phase through the small pores of the material defining the wall of the separator element, and when the separator is a cylindrical element, as shown in FIG. 4a, to thereby permit ingress of that liquid to the separator but to repel or prevent ingress to the liquid which forms the discontinuous phase. For example, in systems in which water is the discontinuous phase, materials are selected as, or are coated on, the wall of the separator which have a critical surface energy or CWST below the surface tension of water. For applications in which water or a liquid having a similar surface tension constitutes the discontinuous phase, materials preferred for use as the discontinuous phase barrier material for forming or coating the separating element wall include silicones, such as a silicone treated paper, and, preferably fluoropolymeric materials of which fluorocarbons or perfluorocarbons or perfluororesins are particularly preferred. Examples of preferred materials for use as the packing or coating in the separator include polytetrafluoroethylene (PTFE) or other polyfluorinated polymers such as fluorinated ethylene propylene (FEP) resins.

A preferred embodiment includes a coating of one of these materials on a stainless steel screen, or a pleated paper pack. Other suitable materials include those disclosed in the United States patent to Miller et al. (U.S. Pat. No. 4,759,782), specifically incorporated herein by reference. Generally, the functional or discontinuous phase barrier material portion, which is also the continuous phase liquid-passing portion, of the separator is selected to have pores smaller than a substantial amount of the droplets of the liquid which originally formed the discontinuous phase. Typically the pore size of the functional part of the separator wall is selected to be about 5 μ to about 140 μ, preferably about 40 μ, to about 100 μ. Most preferably, and particularly when the discontinuous phase is water, the pore size is about 80μ.

Other media suitable for use as the functional or discontinuous phase barrier material portion of the separating element are porous, fibrous fluorocarbon structures of the type described in United States patent to Hurley et al. (U.S. Pat. No. 4,716,074), specifically incorporated herein by reference. Such materials are porous, fibrous structures having good structural integrity which include fluorocarbon polymer fibers and a fluorocarbon binder. Such media, while suitable for use as the barrier medium in the separators in the present invention, previously have been used primarily as support and drainage layers in filtration cartridges.

Although sharing some similarities in composition and preparation with the structures described by Hurley et al., the medium most preferred as the separator barrier medium in the present invention is a calendared, porous, fibrous fluorocarbon structure which includes PTFE fibers in a fluorocarbon binder, preferably a FEP binder. The fibers employed are bleached and water washed PTFE fibers having diameters ranging up to about 70 micrometers, preferably from about 54 to about 70 micrometers. Most preferred are PTFE fibers having a nominal diameter of about 65 micrometers. This material is prepared to have a sheet weight of about 15 to about 35 grams/ft², preferably about 15 to about 25 grams/ft². Most preferred is a medium having a sheet weight of about 21.5 grams/ft^{2.}

FIGS. 4a and 4b illustrate an embodiment of the present invention containing an assembly of seven filter/coalescer assemblies superposed above an assembly of seven liquid separators. However, while this is a preferred embodiment and arrangement, the present invention is not limited thereto and other embodiments and variations are possible. For example, embodiments of the present invention may be disposed horizontally, vertically, or at any angle therebetween. Further, the particular number and arrangement of filtering, coalescing and separating elements depends on the specific mixture being separated. The arrangement shown in FIG. 4a is most suitable, and is preferred, for immiscible liquid mixtures in which the discontinuous phase is more dense than the continuous phase, as for example, a mixture in which water is suspended in a petroleum-based fuel. In such a situation, the more dense discontinuous phase would tend to move in the direction of the separating elements 130 after passing through the coalescing elements 120.

The filter/coalescer of the invention finds particular utility in the filtering and separating of petroleum-based fuels, as described above. A very specific application is in the filtration of high performance jet fuels containing various additives. Due to its ability to successfully filter particulate matter as low as 0.5 μm, the apparatus of the invention can be used for filtering jet fuel in accordance with API 1581 group 2 class B series 3. This test involves the filtration of red iron oxide loaded into a jet fuel stream, followed by injection of water.

1. A purification assembly for separating phases of a solid/liquid/liquid mixture comprising:
at least one cylindrical filter element including a filter medium for removing solid matter from said solid/liquid/liquid mixture, said filter medium having a bubble point of at least about 200 inches of water; and
at least one coalescing element located downstream of said filter element for coalescing into droplets a first liquid of a solid/liquid/liquid mixture, which first liquid is wholly or partly immiscible in and forms a discontinuous phase with a second continuous phase-forming liquid of said solid/liquid/liquid mixture.

2. A method for separating a solid/liquid/liquid mixture into individual phases comprising passing the mixture through at least one filter element including a filter medium having a bubble point of at least about 200 inches of water to remove solid matter from said solid/liquid/liquid mixture and thereafter passing the resultant liquid mixture from which said solid matter has been removed and in which a first liquid is wholly or partially immiscible in and forms a discontinuous phase with a second, continuous phase-forming liquid to a coalescer element to coalesce said first liquid into droplets.

3. A method for separating a solid/liquid/liquid mixture into individual phases, said solid/liquid/liquid mixture comprising water, a petroleum-based liquid, an additive, and solid matter dispersed in at least one of said water and said petroleum-based liquid, said water being wholly or partly immiscible in and forming a discontinuous phase with said petroleum-based, continuous phase-forming liquid, comprising the steps of:
(a) passing the mixture through a filter element including a filter medium having a bubble point of at least about 200 inches of water;
(b) passing the filtered mixture into a coalescer element for coalescing said water into droplets; and
(c) passing the mixture of coalesced water and the petroleum-based liquid to a separator element for separating the coalesced water from the petroleum-based liquid.

4. A purification system capable of separating into individual phases a solid/liquid/liquid mixture comprising a first liquid, a second liquid and solid matter dispersed in at least one of said first and second liquids, said first liquid being wholly or partly immiscible in and forming a discontinuous phase with said second, continuous phase-forming liquid, the system comprising:
(a) a housing;
(b) a liquid inlet in said housing;
(c) a first liquid outlet in said housing;
(d) a second liquid outlet in said housing;
(e) at least one coalescing element in said housing for coalescing said first liquid into droplets; and
(f) at least one filter element in said housing for removing solids from said first and second liquids, said filter element including a filter medium and said filter medium having a bubble point of at least about 200 inches of water, wherein the filter element is positioned in a flow path upstream of the coalescer element.

5. A purification assembly for separating phases of a solid/liquid/liquid mixture including first and second liquids including solids and first and second liquids in which the first liquid is wholly or partially immiscible in and forms a discontinuous phase with the second, continuous phase-forming liquid, the purification assembly comprising a cylindrical filter element including a filter medium for removing solids from said solid/liquid/liquid mixture and a cylindrical coalescer element for coalescing into droplets said first liquid, wherein said cylindrical filter element is detachably mounted coaxially with said cylindrical coalescer to facilitate replacement of the filter element.

6. A method for purifying a solid/liquid/liquid mixture including solids and first and second liquids, the first liquid being wholly or partly immiscible in and forming a discontinuous phase with said second, continuous phase-forming liquid, the method comprising:
directing a flow of the mixture through a first filter element to filter the solids from the mixture and then through a first coalescer element to coalesce the first liquid into droplets;
interrupting the flow through the first filter element and the first coalescer element;
removing the first filter element from a position adjacent to the first coalescer element;
detachably mounting a second filter element adjacent to the first coalescer element; and
directing a flow of the mixture through the second filter element and then through the first coalescer element.
